(19) United States
(12) Patent Application Publication
(10) Pub. No.: US 2015/0175306 A1
(43) Pub. Date: Jun. 25, 2015

(54) METHOD OF DESIGNING A HEATING PLATE

(71) Applicant: YIN-CHIANG WU, Taichung City (TW)

(72) Inventor: YIN-CHIANG WU, Taichung City (TW)

(21) Appl. No.: 14/264,078

(22) Filed: Apr. 29, 2014

(30) Foreign Application Priority Data
Dec. 20, 2013 (TW) 102147357

(51) Int. Cl. B65D 25/00; H05B 3/20

(52) U.S. Cl. CPC B65D 25/00; H05B 3/20

(57) ABSTRACT

A method of designing a specification of an electric heating piece contains step of: providing a width W, a length L, a temperature T, and a voltage V into a limiting condition. The basic value of the width W is 5 mm and is increased to 320 mm by a geometric sequence. A basic value of the length L is 5 mm and is increased to 320 mm by a geometric sequence. A basic value of the temperature T is 10° C. and is increased to 210° C. by an arithmetic sequence, so that a range of the basic value of the temperature T is 10≦T≦210. A basic values of the voltage V is any one of 1.5, 3, 3.7, 4.2, 5, 9, 12, 24, 42, 48, 72, 100, 110, 120, 200, 220, 230, and 240.

### FIELD OF THE INVENTION

The present invention relates to a method of designing a specification of an electric heating piece.

### BACKGROUND OF THE INVENTION

Conventionally, manufacturers cannot design and produce a square or circular electric heating piece by using a regular method. In other words, when a plurality of electric heating pieces of various lengths, widths, outer diameters, and inner diameters are produced, the manufacturers have to consider different temperatures and voltages corresponding to the various lengths, widths, outer diameters, and inner diameters, thus manufacturing circular electric heating pieces with a variety of the lengths, the widths, the outer diameters, and the inner diameters troublesomely.

The present invention has arisen to mitigate and/or obviate the afore-described disadvantages.

### SUMMARY OF THE INVENTION

The primary objective of the present invention is to provide a method of designing a specification of an electric heating piece by which consumer can understand suitable resistance, power, and current of electric heating piece clearly.

Another objective of the present invention is to provide a method of designing a specification of an electric heating piece by which manufacturers can design a variety of products easily and definitely based on a coding manner.

To obtain the above objectives, a method of designing a specification of an electric heating piece is employed to design a square electric heating piece and contains step of: providing a width W, a length L, a temperature T, and a voltage V into a limiting condition;

wherein a basic value of the width W is 5 mm and is increased to 320 mm by a geometric sequence so that a range of the basic value of the width is 5≦W≦320;

a basic value of the length L is 5 mm and is increased to 320 mm by a geometric sequence so that a range of the basic value of the length L is 5≦W≦320;

a basic value of the temperature T is 10° C. and is increased to 210° C. by an arithmetic sequence, so that a range of the basic value of the temperature T is 10≦T≦210;

a basic values of the voltage V is any one of 1.5, 3, 3.7, 4.2, 5, 9, 12, 24, 42, 48, 72, 100, 110, 120, 200, 220, 230, and 240;

wherein each of four ranges of the width, the length, the temperature, and the voltage is selected to make a specifications list or to code specification codes, and a current (A), a power (W) and a resistance (Ω) corresponding to each of the four ranges of the width, the length, the temperature and the voltage which are selected, are provided in the specification list, such that a series of products are designed easily to meet different using requirements.

A method of designing a specification of an electric heating piece is employed to design a circular electric heating piece and comprising step of:

providing an outer diameter D, an inner diameter d, a temperature T, and a voltage V into a limiting condition;

wherein a basic value of the outer diameter D is 5 mm and is increased to 320 mm by a geometric sequence so that a range of the basic value of the width is 5≦W≦320;

a basic value the inner diameter d is 255 (mm) and is decreased to 0 (mm) by a geometric sequence so that a range of the basic value of the inner diameter d is 250≧d≧0

a basic value of the temperature T is 10° C. and is increased to 210° C. by an arithmetic sequence so that a range of the basic value of the temperature T is 10≦T≦210;

a basic values of the voltage V is any one of 1.5, 3, 3.7, 4.2, 5, 9, 12, 24, 42, 48, 72, 100, 110, 120, 200, 220, 230, and 240;

wherein each of four ranges of the outer diameter, the inner diameter, the temperature, and the voltage is selected to make a specifications list or to code specification codes, and a current (A), a power (W) and a resistance (Ω) corresponding to each of the four ranges of the outer diameter, the inner diameter, the temperature and the voltage which are selected, are provided in the specification list, such that a series of products are designed easily to meet different using requirements.

### BRIEF DESCRIPTION OF THE DRAWINGS

FIG. 1 is a schematic view of a square electric heating piece.

FIG. 2 is a schematic view of a circular electric heating piece.

FIG. 3 is a specification list of the square electric heating piece designed by a method of designing a specification of an electric heating piece according to a first embodiment of the present invention.

FIG. 4 is a specification list of the circular electric heating piece designed by a method of designing a specification of an electric heating piece according to a second embodiment of the present invention.

FIG. 5 is a specification list of a product set of the square electric heating piece designed by the method of designing the specification of the electric heating piece according to the first embodiment of the present invention.

FIG. 6 is a specification list of a product set of the circular electric heating piece designed by the method of designing the specification of the electric heating piece according to the second embodiment of the present invention.

### DETAILED DESCRIPTION OF THE PREFERRED EMBODIMENTS

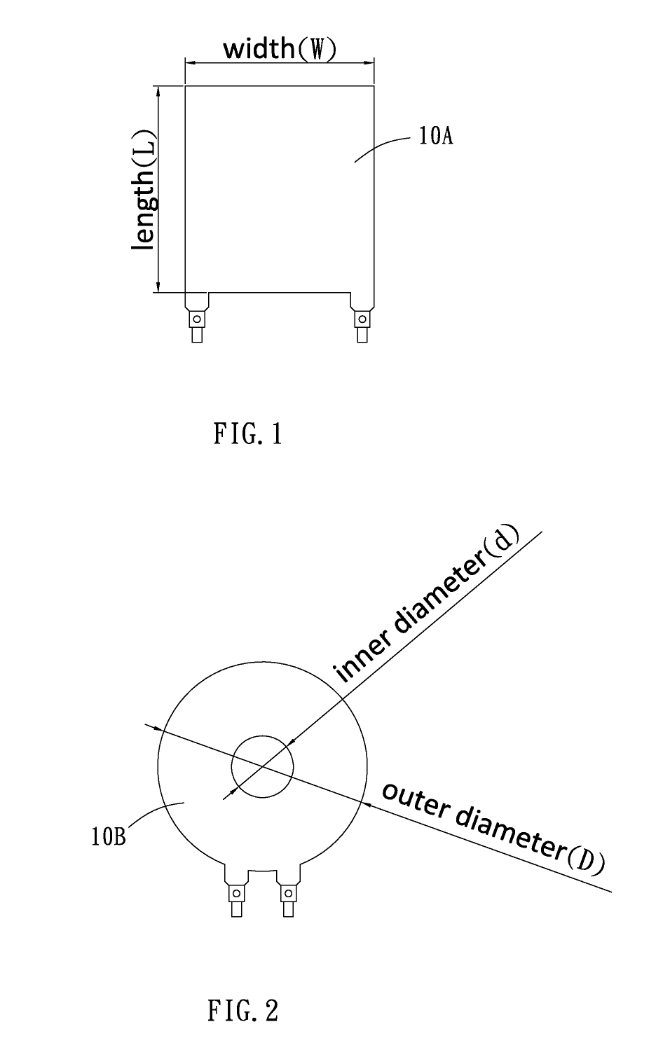

With reference to FIGS. 1 to 6, a method of designing a specification of an electric heating piece according to a first embodiment of the present invention is employed to design a square electric heating piece 10A and comprises step of:

providing a width W (mm), a length L (mm), a temperature T (° C.), and a voltage V (V) into a limiting condition;

wherein a basic value of the width W is 5 (mm) and is increased to 320 mm by a geometric sequence so that a range of the basic value of the width is 5≦W≦320; the basic value of the width W is 5 times a common ratio 1.25 to acquire a width change, and then the width change is rounded off to form an integer value 6. By using such a manner, a plurality of integer values 6, 8, 10, 13, 16, 20, 25, 32, 40, 50, 63, 80, 100, 125, 160, 200, 250, and 320 are obtained accordingly;

A basic value of the length L is 5 (mm) and is increased to 320 mm by a geometric sequence so that a range of the basic value of the length L is 5≦W≦320; the basic value of the length L is 5 times the common ratio 1.25 to acquire a length change, and then the length change is rounded off to form an integer value 6. By using such a manner, a plurality of integer values 6, 8, 10, 13, 16, 20, 25, 32, 40, 50, 63, 80, 100, 125, 160, 200, 250, and 320 are obtained accordingly.

A basic value of the temperature T is 10° C. and is increased to 210° C. by an arithmetic sequence so that a range of the basic value of the temperature T is 10≦T≦210; the basic value of the temperature T is 10 pluses a common difference 10 to acquire a temperature change. By using such a manner, a plurality of temperature values 10, 20, 30, 40, 50, 60, 70, 80, 90, 110, 120, 130, 140, 150, 160, 170, 180, 190, 200, and 210 are obtained accordingly.

The limiting condition of the voltage (V) is a common voltage, such as 1.5, 3, 3.7, 4.2, 5, 9, 12, 24, 42, 48, 72, 100, 110, 120, 200, 220, 230, and 240.

In planning the square electric heating piece, each of four ranges of the width (mm), the length (mm), the temperature (° C.), and the voltage (V) is selected to make a specifications list or to code specification codes. Thereafter, a current (A), a power (W) and a resistance (Ω) corresponding to each of the four ranges of the width (mm), the length (mm), the temperature (° C.) and the voltage (V) which are selected, are provided in the specification list, such that a series of products are designed easily to meet different using requirements.

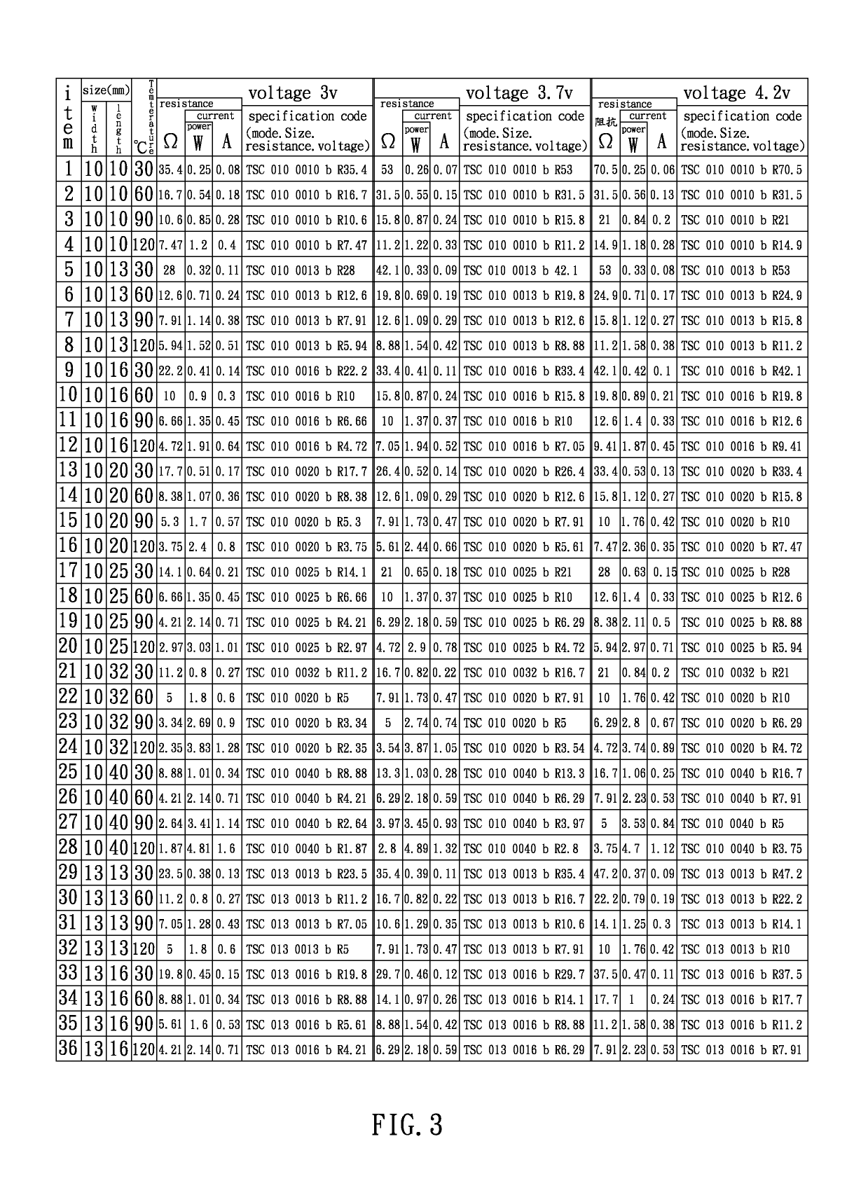

As shown in FIG. 3, a minimum size of the square electric heating piece 10A is started from 10·10, and a maximum size of the square electric heating piece 10A is to 10·40, and the temperatures, including 30° C., 60° C., 90° C., and 120° C. are selected, thereafter the voltages, i.,e, 3V, 3.7V, and 4.2V are selected.

A minimum value of width, a minimum value to a maximum value of length, and a minimum value to a maximum value of temperature are arranged in items to match with 3V, 3.7V, 4.2V of voltage value to list applicable values of current (A), power (W) and resistance (Ω). For example, the limiting conditions, i.e., width 10, length 10, temperatures 30° C., 60° C., 90° C. and 120° C. are listed in items 1 to 4; width 10, length 16, temperatures 30° C., 60° C., 90° C. and 120° C. are listed in items 9 to 12; width 13, length 13, temperatures 30° C., 60° C., 90° C. and 120° C. are listed in items 29 to 32; width 13, length 16, temperatures 30° C., 60° C., 90° C. and 120° C. are listed in items 33 to 36, etc. Since voltage values 3V, 3.7V, 4.2V are different, and each size and temperatures are different as well, their applicable resistance (Ω), power (W), and current (A) are changeable, hence the voltages 3V, 3.7V, 4.2V and their applicable resistance (Ω), power (W), and current (A) are listed separately so that consumer understands suitable resistance (Ω), power (W), and current (A) clearly.

The method of designing the specification of the electric heating piece also comprises step of:

providing width (mm), length (mm), temperature (° C.), and voltage (V) into specification codes of the limiting conditions, wherein the temperature and the voltage change to avoid repeated codes. A change of a temperature code is arranged to replace temperature by using an applicable resistance value (R) of each product, for example, R35.4 in item 1 of FIG. 3 represents resistance value is 35.4Ω. In addition, changes of voltages are coded to a=1.5 v, b=3 v, c=3.7 v, d=4.2 v, e=5 v, f=9 v, g=12 v, h=24 v, i=42 v, j=48 v, k=72 v, A=100 v, B=110 v, C=120 v, D=200 v, E=220V, F=230V, and G=240V.

As arranging a specification code, such as a specification code TSC010 0010 b R35.4, wherein TSC means material code, 010 denotes width 10, 0010 indicates length 10, b represents voltage 3V, and R35.4 denotes when temperature is 30° C., a resistance occurs in this temperature, such that manufacturers can design a variety of products easily and definitely based on such a coding manner.

When a method of designing a specification of an electric heating piece according to a second embodiment of the present invention is employed in a circular electric heating piece 10B, an outer diameter (mm), an inner diameter (mm), a temperature (° C.), and a voltage (V) are provided into a limiting condition; wherein

a basic value the outer diameter D is 5 (mm) and is increased to 320 (mm) by geometric sequence so that a range of the basic value of the outer diameter D is 5≦D≦320. In application, the basic value 5 of the outer diameter is to time a common multiple 1.25, thus obtaining an outer diameter change, and then the outer diameter change is rounded off to form an integer value 6. By using such a manner, a plurality of integer values 6, 8, 10, 13, 16, 20, 25, 32, 40, 50, 63, 80, 100, 125, 160, 200, 250, and 320 are obtained accordingly.

A basic value of the inner diameter d is 250 (mm) and is decreased to 0 (mm) by the geometric sequence so that a range of the basic value of the inner diameter d is 250≧d≧0. In application, the basic value 250 of the inner diameter is to divide by a common multiple 1.25, thus obtaining geometric changes in an inner diameter dimension, and then an array value calculated from 10 bits and a bit of inner diameter value is processed as follows: when the array value is more than 50, this array value is indicated as 5 or 0, and when the array value is less than 5, this array value is indicated as 0, thereby obtaining plural array values, i.e., 250, 200, 160, 125, 100, 80, 64, 50, 40, 32, 25, 20, 16, 13, 10, 8, 6, 5, and 0.

It is to be noted that a basic value the temperature T is 10° C. and t is increased to 210° C. by the geometric sequence so that a range of the basic value of the temperature T is 10°≦T≦210°. In application, the geometric sequence of the temperature of the limitation condition is determined by using the basic value 10 plus a common difference 10 to acquire a series of temperature change arithmetic including 10° C., 20° C., 30° C., 40° C., 50° C., 60° C., 70° C., 80° C., 90° C., 100° C., 110° C., 120° C., 130° C., 140° C., 150° C., 160° C., 170° C., 180° C., 190° C., 200° C., and 210° C.

The limiting condition of the voltage (V) is a common voltage, including 1.5, 3, 3.7, 4.2, 5, 9, 12, 24, 42, 48, 72, 100, 110, 120, 200, 220, 230, and 240.

As planning the product, a voltage value, at least two temperature values, a plurality of outer diameter values, and plural inner diameter values are set; and the voltage value, the at least two temperature values, the plurality of outer diameter values, and the plural inner diameter values are combined together to acquire a specification list of product set in which a current, a power and a resistance corresponding to each product in the product set are provided to consumers, such that a variety of circular electric heating pieces satisfy different using requirements and design demands.

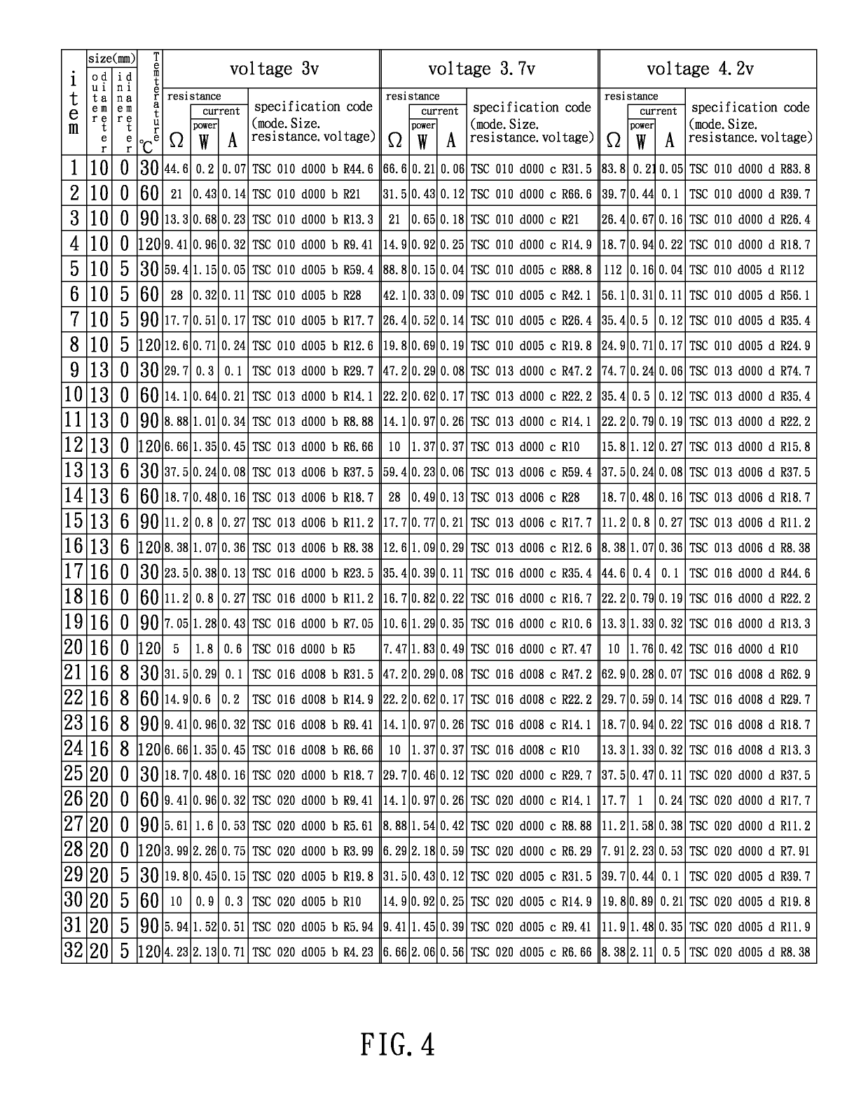

With reference to FIG. 4, when the circular electric heating piece 10B is designed according to above-mentioned limiting conditions, the minimum value of the outer diameter D is 10, and a maximum value of the outer diameter D is 20; the minimum value of the inner diameter d is 0, and a maximum value of the outer diameter D is 8; the temperatures are 30° C., 60° C., 90° C., and 120° C., and the voltages are 3V, 3.7V, and 4.2V.

The minimum value of the outer diameter, the minimum values to the maximum values of the inner diameter and temperature are arranged in items to match with 3V, 3.7V, 4.2V of voltage value and to list applicable values of current (A), power (W) and resistance (Ω). For example, the limiting conditions, i.e., outer diameter 10, inner diameter 10, and the temperatures 30° C., 60° C., 90° C., 120° C. are listed in items 1 to 4; outer diameter 10, inner diameter 5, the temperatures 30° C., 60° C., 90° C., 120° C. are listed in items 5 to 8; outer diameter 13, inner diameter 0, the temperatures 30° C., 60° C., 90° C., 120° C. are listed in items 9 to 12; outer diameter 20, inner diameter 5, the temperatures 30° C., 60° C., 90° C., 120° C. are listed in items 29 to 32, and so on. Since voltage values 3V, 3.7V, 4.2V are different, and each size and temperatures are different as well, their applicable resistance (Ω), power (W), and current (A) are changeable, hence the voltages 3V, 3.7V, 4.2V and their applicable resistance (Ω), power (W), and current (A) are listed separately so that consumer understands suitable resistance (Ω), power (W), and current (A) clearly.

The method of designing the specification of the electric heating piece also comprises step of:

providing outer diameter (mm), inner diameter (mm), temperature (° C.), and voltage (V) into specification codes of the limiting conditions, wherein the temperature and the voltage change to avoid repeated codes. A change of a temperature code is arranged to replace temperature by using an applicable resistance value (R) of each product, for example, R44.6 in item 1 of FIG. 4 represents resistance value 35.4Ω. In addition, changes of voltages are coded to a=1.5 v, b=3 v, c=3.7 v, d=4.2 v, e=5 v, f=9 v, g=12 v, h=24 v, i=42 v, j=48 v, k=72 v, A=100 v, B=110 v, C=120 v, D=200 v, E=220V, F=230V, and G=240V.

As arranging a specification code, such as a specification code TSC010 d000 b R44.6, wherein TSC means material type code, 010 denotes width 10, d000 indicates inner diameter 0, b represents voltage 3V, and R44.6 denotes when temperature is 30° C., a resistance occurs in this temperature, such that manufacturers can design a variety of products easily and definitely based on such a coding manner.

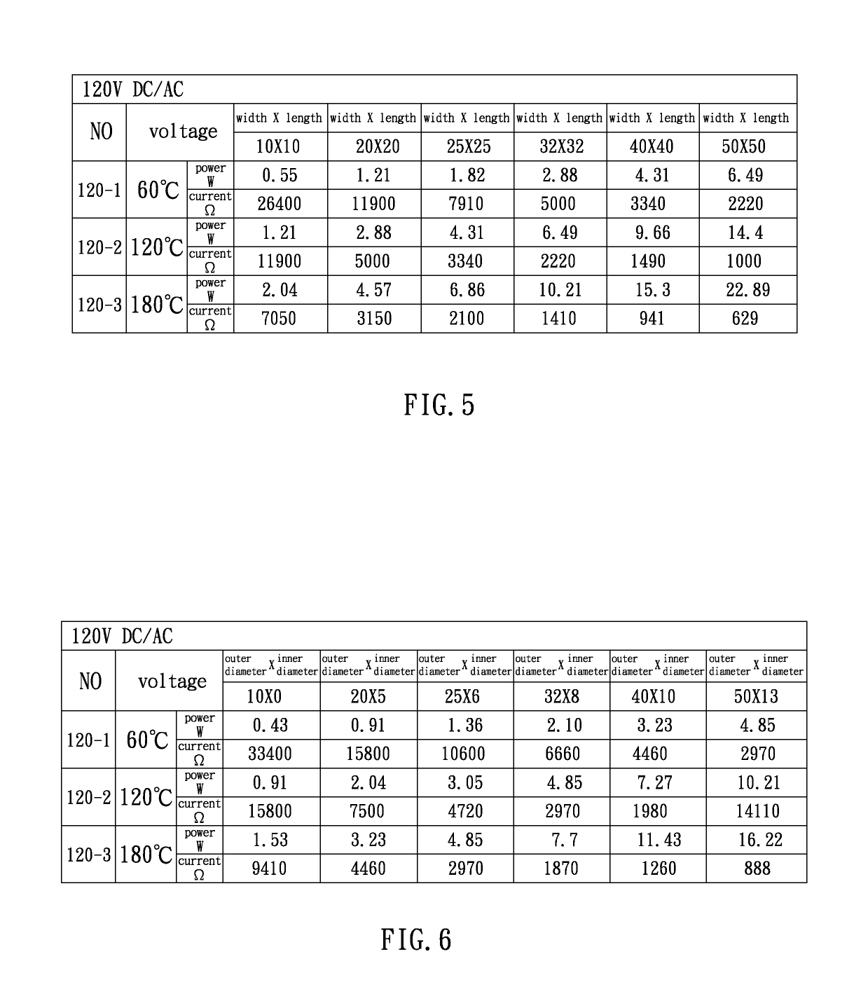

The width, the length, the temperature, and the voltage of the square electric heating piece 10A facilitate a product set in which plural products contains the same voltage, different sizes and temperatures are packaged together. Thereby, when coding in specification list of the product set, a voltage value, at least two temperature values, a plurality of width values, and plural width values are set; and then the voltage value, the at least two temperature values, the plurality of width values, and the plural width values are combined together to acquire the specification list of product set in which a current, a power and a resistance corresponding to each product in the product set are provided to consumers. As illustrated in FIG. 5, when the method of designing the specification of the electric heating piece is applied in the square electric heating piece 10A, a specific voltage is 120V and its code head starts from 120 which represents 120V, such as 120-1, 120-2, and 120-3, and 60° C., 120° C. and 180° C. are selected as temperatures, applicable current (A) and resistance (Ω) are listed, and plural widths·lengths are selected, including 10·10, 20·20, 25·25, 32·32, 40·40, and 50·50.

When the method of designing the specification of the electric heating piece is employed in the circular electric heating piece 10B, a specific voltage and at least two temperature values are combined together to meet plural outer diameters and inner diameters of common size and specification. As illustrated in FIG. 6, when the method of designing the specification of the electric heating piece is applied in the circular electric heating piece 10B, a specific voltage is 120V and its code head starts from 120 which represents 120V, such as 120-1, 120-2, and 120-3, and 60° C., 120° C. and 180° C. are selected as temperatures, thereafter applicable outer diameter and inner diameter are selected, including 10·0, 20·5, 25·6, 32·8, 40·10, and 50·13.

Accordingly, the width (the outer diameter), the length (the inner diameter), the temperature, and the voltage are cooperated to obtain the value corresponding to the specification list or the specification code, and then an applicable size, an applicable temperature, and an applicable voltage of each product are selected and listed in the specification list to provide suitable current (A), power (W) and resistance (Ω), hence production and sales management of the electric heating piece are regularly match with various lengths and widths (the outer diameters and the inner diameters), the temperatures and the voltages, thereby designing electric heating piece of various specifications.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method of designing a specification of an electric heating piece being employed to design a square electric heating piece and comprising step of:
providing a width W, a length L, a temperature T, and a voltage V into a limiting condition;
wherein a basic value of the width W is 5 mm and is increased to 320 mm by a geometric sequence so that a range of the basic value of the width is 5≦W≦320;
a basic value of the length L is 5 mm and is increased to 320 mm by a geometric sequence so that a range of the basic value of the length L is 5≦W≦320;
a basic value of the temperature T is 10° C. and is increased to 210° C. by an arithmetic sequence, so that a range of the basic value of the temperature T is 10≦T≦210;
a basic values of the voltage V is any one of 1.5, 3, 3.7, 4.2, 5, 9, 12, 24, 42, 48, 72, 100, 110, 120, 200, 220, 230, and 240;
wherein each of four ranges of the width, the length, the temperature, and the voltage is selected to make a specifications list or to code specification codes, and a current (A), a power (W) and a resistance (Ω) corresponding to each of the four ranges of the width, the length, the temperature and the voltage which are selected, are provided in the specification list, such that a series of products are designed easily to meet different using requirements.

2. The method of designing the specification of the electric heating piece as claimed in claim 1, wherein the basic value of the width is 5 times a common ratio 1.25 to acquire a width change, and then the width change is rounded off to form an integer value.

3. The method of designing the specification of the electric heating piece as claimed in claim 1, wherein the basic value of the length is 5 times a common ratio 1.25 to acquire a length change, and then the length change is rounded off to form an integer value.

4. The method of designing the specification of the electric heating piece as claimed in claim 1, wherein the basic value of the temperature is 10 pluses a common difference 10 to acquire a temperature change.

5. The method of designing the specification of the electric heating piece as claimed in claim 1 further comprises setting a voltage value, at least two temperature values, a plurality of width values, and plural width values; combining the voltage value, the at least two temperature values, the plurality of width values, and the plural width values together to acquire a specification list of product set in which a current, a power and a resistance corresponding to each product in the product set are provided to consumers.

6. A method of designing a specification of an electric heating piece being employed to design a circular electric heating piece and comprising step of:
providing an outer diameter D, an inner diameter d, a temperature T, and a voltage V into a limiting condition;
wherein a basic value of the outer diameter D is 5 mm and is increased to 320 mm by a geometric sequence so that a range of the basic value of the width is 5≦W≦320;
a basic value the inner diameter d is 255 (mm) and is decreased to 0 (mm) by a geometric sequence so that a range of the basic value of the inner diameter d is 250≧d≧0
a basic value of the temperature T is 10° C. and is increased to 210° C. by an arithmetic sequence so that a range of the basic value of the temperature T is 10≦T≦210;
a basic values of the voltage V is any one of 1.5, 3, 3.7, 4.2, 5, 9, 12, 24, 42, 48, 72, 100, 110, 120, 200, 220, 230, and 240;
wherein each of four ranges of the outer diameter, the inner diameter, the temperature, and the voltage is selected to make a specifications list or to code specification codes, and a current (A), a power (W) and a resistance (Ω) corresponding to each of the four ranges of the outer diameter, the inner diameter, the temperature and the voltage which are selected, are provided in the specification list, such that a series of products are designed easily to meet different using requirements.

7. The method of designing the specification of the electric heating piece as claimed in claim 6, wherein the basic value of the outer diameter is 5 times a common multiple 1.25 to acquire an outer diameter change, and then the outer diameter change is rounded off to form an integer value.

8. The display structure for the tool box as claimed in claim 6, wherein the basic value 250 of the inner diameter is to divide by a common multiple 1.25 to obtain a geometric change, and then an array value calculated from 10 bits and a bit of inner diameter value is processed: when the array value is more than 50, this array value is indicated as 5 or 0, and when the array value is less than 5, this array value is indicated as 0.

9. The display structure for the tool box as claimed in claim 6, wherein the basic value of the temperature is 10 pluses a common difference 10 to acquire a temperature change.

10. The display structure for the tool box as claimed in claim 6 further comprises setting a voltage value, at least two temperature values, a plurality of outer diameter values, and plural inner diameter values; combining the voltage value, the at least two temperature values, the plurality of outer diameter values, and the plural inner diameter values together to acquire a specification list of product set in which a current, a power and a resistance corresponding to each product in the product set are provided to consumers.
